(19) United States
(12) Patent Application Publication
(10) Pub. No.: US 2012/0199527 A1
(43) Pub. Date: Aug. 9, 2012

(54) CERAMIC MEDIA FOR TREATMENT OF A FLUID

(76) Inventors: John Stewart Reid, Wooster, OH (US); Daniel Christopher Sherman, Hudson, OH (US)

(21) Appl. No.: 13/500,078

(22) PCT Filed: Oct. 8, 2010
(86) PCT No.: PCT/US2010/051886

§ 371 Date: Apr. 4, 2012

Related U.S. Application Data
(60) Provisional application No. 61/250,139, filed on Oct. 9, 2009.

(51) Int. Cl. C02F 1/68; C09K 3/00

(52) U.S. Cl. 210/263; 252/182.32

(57) ABSTRACT

A ceramic media for increasing the pH of a fluid, such as potable water, has a composition comprising at least 40 weight percent silicon oxide, 25 weight percent of a mixture of alkaline earth oxides and less than 5 weight percent alumina. An apparatus that changes the pH of a fluid by allowing the fluid to flow therein, contact the media and then exit the apparatus is also disclosed.

### CROSS-REFERENCE TO RELATED APPLICATION

This application claims the benefit of U.S. Provisional Application No. 61/250,139 filed Oct. 9, 2009.

### BACKGROUND OF THE INVENTION

This invention generally relates to ceramic media that are used to alter a fluid's chemical characteristic by contacting the fluid with the media. More particularly, this invention is concerned with increasing the pH of a consumable fluid.

Examples of patents and published applications that describe processes and/or materials that purify or otherwise treat a fluid include U.S. 2006/0037902, U.S. Pat. No. 5,118,655 and U.S. Pat. No. 7,288,498.

### SUMMARY

Embodiments of the present invention provide ceramic media that can increase the pH of a fluid by at least one pH unit within a few minutes of the fluid contacting the media. The media may by used in a portable or stationary apparatus provided the fluid is allowed to enter the apparatus, contact the media and then exit the apparatus. By altering the physical and chemical characteristics of the media as described below, the rate at which the pH of the fluid changes and the maximum increase in the pH can be controlled.

In one embodiment, a porous ceramic media of this invention has a composition comprising at least 40 weight percent silicon oxide and at least 25 weight percent of a mixture of alkaline earth metal oxides. The mixture comprises less than 5 weight percent alumina. The percentages are based on the total weight of the media's oxides. The porosity of the media exceeds 40% and does not exceed 70%.

In another embodiment, this invention is an apparatus comprising a fluid and at least one porous ceramic media in contact with the fluid. The composition of the media comprises at least 40 weight percent silicon oxide and at least 25 weight percent of a mixture of alkaline earth metal oxides wherein the mixture comprises less than 5 weight percent alumina. The percentages are based on the total weight of the media's oxides. The porosity of the media exceeds 40% and to does not exceed 70%.

### BRIEF DESCRIPTION OF THE DRAWINGS

FIG. 1 is a cross-sectional view of an apparatus of this invention.

### DETAILED DESCRIPTION

An essential ingredient of an individual's daily diet is a sufficient quantity of potable water. The need for the body to quickly digest and utilize the water may be particularly acute for athletes, such as long distance runners, and anyone working for hours in the sun. While drinking potable water that has a pH of approximately 7 is suitable for many people engaged in routine activities, there is recognition by some people that increasing the pH of the water to approximately 8 or 9 improves the health of the individual more quickly than would be achieved if a similar quantity of water having a pH of 7 was consumed within the same period of time. While there are known ways to increase the pH of a fluid, some of the established procedures have drawbacks that may negatively impact the cost of increasing the pH of the fluid and/or other characteristics such as the taste of the fluid. For example, one process for increasing the pH of the fluid uses expensive stationary equipment that mixes the water with a powder which dissolves therein thereby increasing the pH of the fluid. In contrast, the invention described herein provides ceramic media that can increase the pH of water by 1 to 2 pH units within a short period of time by allowing the fluid to contact the media.

The chemical composition of the media may include minimum amounts of both silica and a mixture of alkaline earth compounds. The chemical composition of the media is determined using X-ray fluorescence (XRF) or Inductively coupled plasma (ICP) methods. The quantity of aluminum containing compounds is kept below a threshold amount in order to control the quantity of aluminum transferred to the fluid. The quantity of SiO₂ in the media may be at least 40 weigh percent. As used herein, the quantity of SiO₂, as well as the quantities of the other compounds, is listed in weight percent based on the total weight of the media's oxides. The media may contain even higher quantities of SiO₂ such as 45, 50, 60 or 65 weight percent. Intermediate quantities of SiO₂, such as 47.15 and 50.47 weight percent are also feasible. The quantity of SiO₂ should not exceed 75 weight percent. The total weight of alkaline earth oxides may be between 25 and 60 weight percent. A lower total quantity of alkaline earth compounds, such as 50 weight percent, is also feasible.

The mixture of alkaline earth compounds may contain 10 weight percent calcium oxide (CaO), five weight percent magnesium oxide (MgO), and no more than five weight percent alumina (Al₂O₃). The quantity of calcium oxide may be less than 50 weight percent or even 40 weight percent. The quantity of magnesium oxide may be greater than 8 weight percent and less than 30 weight percent. The quantity of alumina may be less than 3 weight percent or even 2 weight percent. Compounds such as potassium oxide (K₂0), titanium oxide (TiO₂) and iron oxide (Fe₂O₃) may also exist. The total quantity of oxides other than silica, magnesium oxide, calcium oxide and alumina may be less than 3 weight percent.

Controlling the chemical composition of the media ultimately determines the chemicals that are available in the media to contact the fluid. The inventors have discovered that the presence of certain elements, such as calcium and magnesium, may impact the desired rapid increase in the pH of the fluid while avoiding problems associated with taste, smell, etc. Too much Al released into the fluid is not good because accumulation of Al in the body over time may have negative health effects. Levels of Ca and Mg that are too high can result in the increase in pH to a very high level (i.e. over 11) which can result in a bad taste to the water. Other combinations of chemicals can also result in a bad taste, either due to a very high pH or due to impurities in the materials.

In addition to the media's chemical characteristics, some of the media's physical characteristics, such as porosity and density, may be used to control the to rate at which the pH of the fluid increases. As used herein, porosity refers to open pore porosity and is determined by a high pressure mercury porosimetry method using a Micromeritics Autopore model 9200. The porosity of the ceramic media may range exceed 40 percent and should not exceed 70 percent. A porosity range between 50 and 65 percent is workable. As used herein, density of the media may be described as the media's apparent density which is calculated by dividing the media's mass by the media's apparent volume. The media's apparent volume is determined by measuring the media's outer dimensions and then calculating the media's volume. The media's apparent volume includes the volume of the media's open pores and closed pores. The density of porous ceramic media of this invention may be at least 0.9 g/cc and less than 2.0 g/cc. Media with density between 1.0 g/cc and 1.6 g/cc are workable.

In some applications, such as portable bottles that contain potable water, the rate at which the pH of the fluid increases may be important to commercial viability of the process. In other applications, the absolute difference between the initial pH of the fluid and the resting pH of the fluid may also be important. As used herein, the initial pH of a fluid is the pH of the fluid before any contact with the media. The first resting pH describes the pH of the fluid after a relatively short contact time, such as after the fluid has contacted the media for at least one minute but less than two minutes. The final resting pH of the fluid is the pH of the fluid after it has contacted the media for more than twenty four hours.

When potable water is the fluid that will be contacting the media, the fluid's initial pH is considered to be generally in the range of 6.5 to 7.5. Preferably, the media contact with potable water produces a first resting pH of the fluid of at least 8.5 to 9.5, or an increase in the pH of at least 2 pH units within one to two minutes of contact time. The final resting pH of the potable water should not exceed a value of approximately 10.5. Preferably, the final resting pH of the potable water will be at least 2 pH units greater than, but not be more than 3 pH units greater than the initial pH of the water. The rate of change of the fluid's pH and the absolute change of the fluid's pH can be directly impacted by the to quantity of fluid and/or the quantity of media disposed within an apparatus. Consequently, the quantities of fluid and media disposed within the apparatus may need to be altered to achieve the change in the fluid's pH described above.

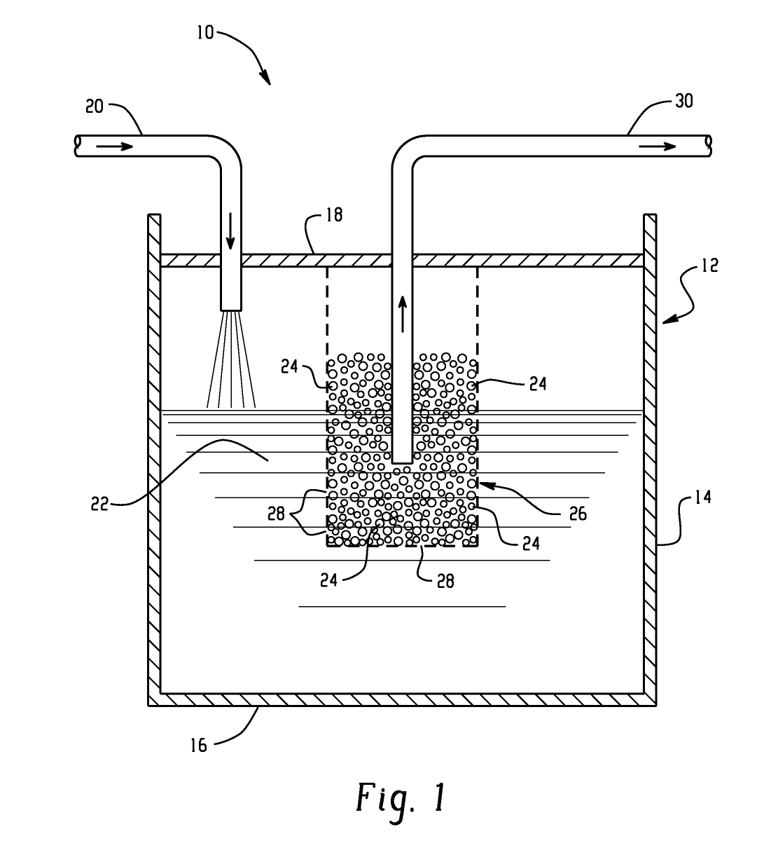

Shown in FIG. 1 is a cross-sectional view of an apparatus 10 of this invention. Container 12 includes sidewall 14, bottom 16 and top 18 secured to the sidewall. Inlet pipe 20 allows fluid 22 to flow into the container. A plurality of ceramic media 24 are disposed within media retaining basket 26 which has numerous perforations 28 therethrough thereby allowing the fluid to flow into the basket and contact the media. The plurality of media forms a matrix which may be referred to herein as a bed of media. Outlet pipe 30 provides a path for the fluid that has flowed through the bed of media to be removed from the container. The apparatus shown in FIG. 1 may be stationary or portable, large or small, used by consumers or in an industrial process. The fluid, for example, could be a consumable fluid such as potable water, a valuable industrial fluid such as crude oil, or a contaminated waste stream that needs to be treated prior to further processing.

### EXAMPLES

To illustrate certain embodiments of this invention, six lots of ceramic media were manufactured and placed into separate containers having potable water disposed therein. Lots A, B, C and D disclose embodiments having commercially desirable characteristics. In contrast, lots E and F disclose lots having an undesirable characteristic. Table 1 contains analytical data on all six lots.

Lot A was manufactured by mixing 5.44 Kg (12 lbs) of a ceramic powder mixture and 0.816 Kg (1.8 lbs) of water. The ceramic mix ingredients were 2.18 Kg (4.8) lbs of milled dolomite, 2.72 (6 lbs) of ground silica sand, and 0.544 Kg (1.2 lbs) of talc. This mixture was homogenized and then formed into small particles in an agglomeration process in a rotating mixer, with an addition of 218 grams of starch as a binder. The formed particles were primarily in the range of approximately 0.5 mm to 2 mm diameter. These particles were dried in an oven and fired up to a temperature of 1050° C. for a 3 hour hold time. The resulting media has a particle density of 1.46 g/cc, 52.0% porosity, and the following chemical analysis 14.5% CaO, 15.8% MgO, 67.9% SiO₂, approximately 1.4% Al₂O₃ and less than 1% other oxides.

A 40 g (37cc of media) sample of the media from Lot A was placed into 150 ml of de-ionized (DI) water in a 250 cc beaker and the pH was measured.

The pH increased from about 7 to about 8 in less than one minute. The pH after 15 minutes increased to 9.4. The media was allowed to stand in the 150 ml of water for 24 hours, and then the water was separated from the media and a chemical analysis of the water was completed by Inductively Coupled Plasma. The analysis results were 93 ppm Ca, 4.9 ppm Mg, <0.1ppm K, 3.4 ppm Na, and 0.1 ppm Al.

A sample of the media was placed in water as before, with 40 g media in 150 ml DI water, and after one minute the water was decanted off. This semi-wet media was then added to a fresh beaker of 150 ml DI water and the pH increased to 9.3 in less than 1 minute, and after 15 minutes the pH was about 9.5.

Lot B was similar to Lot A except the dolomite content was increased from 40% of the mix to 60%. A mixture of three ceramic raw materials was prepared by combining 5.44 Kg (12 lbs) of ceramic mix and 0.816 Kg (1.8 lbs) of water. The ceramic mix ingredients were 3.27 Kg (7.2 lbs) of milled dolomite, 1.63 Kg (3.6 lbs) of ground silica sand, and 0.54 Kg (1.2 lbs) of talc. This mixture was homogenized and then formed into small particles in an agglomeration process in a rotating mixer, with an addition of 218 grams of starch as a binder. The formed particles were primarily in the range of approximately 0 5 mm to 2 mm diameter. These particles were dried in an oven and fired up to a temperature of 1225° C. for a 3 hour hold time. The resulting media has a particle density of 1.11 g/cc, 62.9% porosity, and a chemical analysis consisting of 24.4% CaO, 24.5% MgO, 49.7% SiO₂, and about 1.0% Al₂O₃ and less than 1% other oxides.

A 28 g (37 cc) sample of the media was placed into 150 ml of de-ionized water in a 250 cc beaker and the pH was measured. The pH increased from about 7 to about 9.4 in less than one minute. The pH after 15 minutes increased to 10.2. The media was allowed to stand in the 150 ml of water for 24 hours, and then the water was separated from the media and a chemical analysis of the water was completed by ICP. The analysis results were 18 ppm Ca, 4.1 ppm Mg, 1.3 ppm K, 0.25 ppm Na, and 0.1 ppm Al.

Lot C was similar to Lot B except the alkaline earth compound was a dolomitic limestone rather than actual dolomite. A mixture of three ceramic raw materials was prepared by combining 22.68 Kg (50 lbs) of ceramic mix and 4.99 Kg (11 lbs) of water. The ceramic mix ingredients were 13.61 Kg (30 lbs) of milled dolomitic limestone, 6.80 Kg (15 lbs) of ground silica sand, and 2.26 Kg (5 lbs) of talc. This mixture was homogenized in a mixer and then formed into small particles by extruding through a die. The formed particles were primarily in the range of approximately 3.5 mm to 4 mm diameter, and 3.5 to 4 mm in length. These particles were dried in an oven and fired up to a temperature of 1225° C. for a 3 hour hold time. The resulting media had a particle density of 1.14 g/cc, 60% porosity, and the following chemical analysis: 36.9% CaO, 11.2% MgO, 50.47% SiO₂, and about 0.9% Al₂O₃ and less than 1% other oxides.

A 25 g (37 cc) sample of the media was placed into 150 ml of de-ionized water in a 250 cc beaker and the pH was measured. The pH increased from about 7 to about 9.4 in less than one minute. The pH after 15 minutes increased to 10.3. The media was allowed to stand in the 150 ml of water for 24 hours, and then the water was separated from the media and a chemical analysis on the water was completed by ICP. The analysis results were 27 ppm Ca, 3.3 ppm Mg, 5.5 ppm K, 0.7 ppm Na, and 0.06 ppm Al.

Lot D was similar to Lot C except that half of the talc content was replaced with potassium carbonate. A mixture of four ceramic raw materials was prepared by combining 22.68 Kg (50 lbs) of ceramic mix and 4.22 Kg (9.3 lbs) of water. The ceramic mix ingredients were 13.61 Kg (30 lbs) of milled dolomitic limestone, 6.80 Kg (15 lbs) of ground silica sand, 1.13 Kg (2.5 lbs) of talc, and 1.13 Kg (2.5 lbs) of K₂CO₃. This mixture was homogenized in a mixer and then formed into small particles by extruding through a die. The formed particles were to primarily in the range of approximately 3.5 to 4 mm diameter, and 3.5 to 4 mm in length. These particles were dried in an oven and fired up to a temperature of 1225° C. for a 3 hour hold time. The resulting media has a particle density of 1.14 g/cc, 60.4% porosity, and the following chemical analysis 37.5% CaO, 9.2% MgO, 47.15% SiO₂, 0.9% Al₂O₃, 4.8% K₂O and less than 1% other oxides.

A 25 g (37cc) sample of the media in Lot D was placed into 150 ml of de-ionized water in a 250 cc beaker and the pH was measured. The pH increased to about 9.98 after standing in contact with the media overnight. The media was allowed to stand in the 150 ml of water for 24 hours, and then the water was separated from the media and a chemical analysis of the water was completed by ICP. The analytical results were 4.2 ppm Ca, 1.4 ppm Mg, 300 ppm K, 3 ppm Na, and 0 ppm Al (below the detection limit of 0.01 ppm).

Lot E was similar to Lots A and B except that the silica and talc were replaced with bentonite. A mixture of three ceramic raw materials was prepared by combining 22.68 Kg (50 lbs) of ceramic mix and 3.63 Kg (8 lbs) of water. The ceramic mix ingredients were 13.61 Kg (30 lbs) of milled dolomite, 4.54 Kg (10 lbs) of milled limestone, and 4.54 Kg (10 lbs) of western sodium bentonite. This mixture was homogenized in a mixer and then formed into small particles by extruding through a die. The formed particles were primarily in the range of approximately 3.5 to 4 mm diameter, and 3.5 to 4 mm in length. These particles were dried in an oven and fired up to a temperature of 900° C. for a 3 hour hold time. The resulting media has a particle density of 1.26 g/cc, 55 to 60% porosity, and the following chemical analysis 47% CaO, 26% MgO, 20.5% SiO₂, 6.5% Al₂O₃, 0.2% K₂O and less than 2.5% other oxides.

A 25 g (37cc) sample of the media was placed into 150 ml of de-ionized water in a 250 cc beaker and the pH was measured. The pH increased to about 11.1 after standing in contact with the media overnight. The media was allowed to stand in the 150 ml of water for 24 hours, and then the water was separated from the media and a chemical analysis was completed by ICP on the water. The analysis results were: 230 ppm Ca, 0.8 ppm Mg, 110 ppm K, 270 ppm Na, and 17 ppm Al.

Lot F was similar to Lot E except that the bentonite was replaced with ball clay. A mixture of two ceramic raw materials was prepared by combining 22.68 Kg (50 lbs) of ceramic mix and 3.86 Kg (8.5 lbs) of water. The ceramic mix ingredients were 13.61 Kg (30 lbs) of milled dolomitic limestone, and 9.07 Kg (20 lbs) of ball clay. This mixture was homogenized in a mixer and then formed into small particles by extruding through a die. The formed particles were primarily in the range of approximately 3.5 to 4 mm diameter, and 3.5 to 4 mm in length. These particles were dried in an oven and fired up to a temperature of 900° C. for a 2 hour hold time. The resulting media has a particle density of 1.60 g/cc, 29.3% porosity, and a chemical analysis of 38.6% CaO, 7.4% MgO, 36.3% SiO₂, 15.3% Al₂O₃, 0.3% K₂O and less than 2% other oxides.

A 59 g (37 cc) sample of the media was placed into 150 ml of de-ionized water in a 250 cc beaker and the pH was measured. The pH increased to about 9.59 in one minute and to 10.68 after standing in contact with the media overnight. The media was allowed to stand in the 150 ml of water for 24 hours, and then the water was separated from the media and a chemical analysis was completed by ICP on the water. The analysis results were 164 ppm Ca, 0.11 ppm Mg, 1.1 ppm K, 5.5 ppm Na, and 23.4 ppm Al.

Shown in Table 1 are the results of the chemical analysis of the media and the fluid after contacting the media as described above. The alumina content of lots A, B, C and D, was less than 5 percent for all lots. In contrast, the alumina content of lots E and F was greater than five percent. Similarly, the aluminum content of the fluid that contacted media from lots A, B, C or D was much less than 2 ppm while the aluminum content of the fluid that contacted media from lots E or F was much greater than 2 ppm.

TABLE 1

| | Chemical Analysis of Media | | | | | | | | |
|---|---|---|---|---|---|---|---|---|---|
| | (weight percent of total oxides) | | | | | | | ICP Analysis | |
| | | | | | | | Other | of Fluid (ppm) | |
| Lot | CaO | MgO | CaO + MgO | SiO₂ | Al₂O₃ | K₂O | Oxides | Na | Al |
| A | 14.5 | 15.8 | 30.3 | 67.9 | 1.4 | | <1 | 3.4 | 0.1 |
| B | 24.4 | 24.5 | 48.9 | 49.7 | 1.0 | | <1 | 0.25 | 0.1 |
| C | 36.9 | 11.2 | 48.1 | 50.5 | 0.9 | | <1 | 0.7 | 0.06 |
| D | 37.5 | 9.2 | 46.7 | 47.15 | 0.9 | 4.8 | <1 | 3 | 0 |
| E | 47 | 26 | 73 | 20.5 | 6.5 | 0.2 | 2.5 | 270 | 17 |
| F | 38.6 | 7.4 | 46.0 | 36.3 | 15.3 | 0.3 | <2 | 5.5 | 23.4 |

Collectively, the data in table 1 and the description above demonstrate that only the media in lots A, B, C and D increased the pH of the fluid as desired and did not allow aluminum in the media to be dissolved into the fluid above a concentration of 5 ppm. Consequently, only media from these lots were able to alter the pH of the fluid at an acceptable rate while maintaining low aluminum concentration in the treated fluid.

The above description is considered that of particular embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law.

What is claimed is:

1. A porous ceramic media having a composition comprising at least 40 weight percent silicon oxide and at least 25 weight percent of a mixture of alkaline earth metal oxides wherein said mixture comprises less than 5 weight percent alumina, said percentages based on the total weight of the media's oxides, and wherein the porosity of said media exceeds 40% and does not exceed 70%.

2. The ceramic media of claim 1 wherein said mixture comprises less than 3 weight percent alumina.

3. The ceramic media of claim 1 wherein said mixture comprises less than 2 weight percent alumina.

4. The ceramic media of claim 1 wherein said mixture comprises at least 10 weight percent calcium oxide.

5. The ceramic media of claim 1 wherein said mixture comprises less than 50 weight percent calcium oxide.

6. The ceramic media of claim 1 wherein said mixture comprises less than 40 weight percent calcium oxide.

7. The ceramic media of claim 1 wherein said mixture comprises at least 5 weight percent magnesium oxide.

8. The ceramic media of claim 3 wherein said mixture comprises at least 8 weight percent magnesium oxide.

9. The ceramic media of claim 1 wherein said porosity exceeds 50%.

10. The ceramic media of claim 1 wherein said porosity does not exceed 65%.

11. The ceramic media of claim 1 comprises a particle density greater than 0.9 cc/g.

12. The ceramic media of claim 1 comprises a particle density less than 1.6 cc/g.

13. An apparatus comprising a fluid and at least one porous ceramic media in contact with said fluid wherein the composition of said media comprises at least 40 weight percent silicon oxide and at least 25 weight percent of a mixture of alkaline earth metal oxides wherein said mixture comprises less than 5 weight percent alumina, said percentages based on the total weight of the media's oxides, and wherein the porosity of said media exceeds 40% and does not exceed 70%.

14. The apparatus of claim 13 wherein said mixture comprises less than 3 weight percent alumina.

15. The apparatus of claim 13 wherein said mixture comprises less than 2 weight percent alumina.

16. The apparatus of claim 13 wherein said mixture comprises between 10 weight percent and 50 weight percent calcium oxide

17. The apparatus of claim 13 wherein the mixture of alkaline earth metal oxides does not exceed 60 weight percent.

18. The apparatus of claim 13 wherein the mixture of alkaline earth metal oxides does not exceed 50 weight percent.

19. The apparatus of claim 13 wherein said porosity exceeds 50%.

20. The apparatus of claim 13 wherein said porosity does not exceed 65%.

21. The apparatus of claim 13 wherein said media comprises a density of at least 0.9 g/cc.

22. The apparatus of claim 13 wherein said media comprises a density of at least 1.0 g/cc.

23. The apparatus of claim 13 wherein said media comprises a density less than 2.0 g/cc.

24. The apparatus of claim 13 wherein said media comprises a density less than 1.6 g/cc.

25. The apparatus of claim 13 comprises a plurality of ceramic components.

26. The apparatus of claim 13 wherein said plurality of ceramic components forms a matrix through which said fluid flows.

27. The apparatus of claim 13 wherein said fluid comprises potable water.
